(19) United States
(12) Patent Application Publication
(10) Pub. No.: US 2009/0066112 A1
(43) Pub. Date: Mar. 12, 2009

(54) Vehicle cover

(76) Inventor: Sergey Sharapov, San Francisco, CA (US)

Correspondence Address: Sergey Sharapov, 18 Dorado Terrace # 7, San Francisco, CA, 94112, US

(21) Appl. No.: 11/900,426

(22) Filed: Sep. 12, 2007

(51) Int. Cl. B60J 11/04

(52) U.S. Cl. 296/136.1

(57) ABSTRACT

A vehicle cover made from a thin flexible material such as silk, which is provided with a plurality of transversely arranged resilient strips of metal or plastic. Pulling cords are threaded through the holes formed on the ends of the resilient strips so that when the cords are pulled in the opposite directions or when one ends of the strips are fixed and the other ends are pulled, the resilient strips are curved or buckled upward stretching the web and forming a dome-like canopy above the vehicle roof for protection of the vehicle from sun rays or precipitations. After the resilient strips are deformed, the cords are clamped together and the ends of the cord bundles are locked to the vehicle body, e.g., by hooks. The cover of the invention can be easily wound into a roll.

### FIELD OF THE INVENTION

The present invention relates to vehicle covers, and in particular to vehicle covers that can be used for protection of a vehicle parked in open air from heat, sunrays, birds' droppings, hail, etc. More specifically, the invention relates to a vehicle cover that forms dome-like upwardly curved canopy above the roof of the vehicle.

### BACKGROUND OF THE INVENTION

In many countries, the automobile has become the most common method of transportation. Most automobiles are manufactured primarily of metal, and the metal is painted to protect it from oxidation and other influences detrimental to the finish. Automobile surface finish degradation may be caused by sun rays, bird droppings, tree sap and pollens, snow and ice, frost, etc.

One way to prevent damage to the surface finish of an automobile is to store the car in a garage when it is not being used. Unfortunately, there are many more cars than garages, so this solution leaves many cars outdoors.

U.S. Pat. No. 4,805,654 issued in 1989 to Kuo-Hsin-Wang provides an umbrella-type sun shield for automobiles. The sun shield has a collapsible framework for supporting a flexible cloth. The framework has at least three legs radially and isometrically extended from the framework. In the free end of each leg, there is a sucker adapted to attach to the roof of an automobile. Therefore, the shield can be mounted above an automobile to shade it from the unpleasant and damaging effects of the sun's rays, and it can be detached from the roof of the automobile and folded into the trunk of the automobile.

This device has a complicated construction and can be blown out from the roof of the vehicle by gusts of winds. The installation and removal of the device requires opening and closing of the umbrella-type mechanism. If the metal spikes of the shield are bent, e.g., by the wind gusts, the damage becomes irreversible and the device has to be discarded.

Tung-Chow was granted U.S. Pat. No. 4,834,446 issued in 1989 for a road vehicle flexible cover, which is stored in a box in the vehicle trunk. While this design provided for motorized retraction of the cover, its storage box occupied a substantial amount of the trunk floor space, right in the center part of the trunk floor. In addition, this design requires that the trunk be opened and closed every time the cover is deployed or stored. The '446 design is also necessarily complex because it uses an electric motor with an electrical wire running to the dash of the vehicle. The protective canvas comprises a folded bundle, which, after unwinding from the storage box, has to be unfolded for covering the top and sides of the vehicle. Furthermore, the cover of this type does not provide a space between the cover and the vehicle body so that the cover of this type does not protect the vehicle from heating.

One variant of the vehicle cover solution is the self-storing vehicle cover. This type of cover is typically provided in a container, which may be used to store the cover. When the cover is to be used, the cover is removed from the container, and when the cover is to be stored, it is returned to the container. A number of self-storing vehicle covers have been patented, but they all suffer from various problems.

For example, U.S. Pat. No. 5,516,181 granted to Thompson in 1996 discloses a roll-up vehicle cover. This cover could be rolled up around a cylinder, which could then be stored in the vehicle's trunk. While this design is provided for a storable cover, it is inconvenient and cumbersome to use, because after use, the cover has to be removed from the vehicle roof, manually rolled up, the bundle carried to the trunk of the vehicle, the trunk opened, the bundle placed inside, and the trunk closed. Deployment of this cover requires all these steps to be performed, but in the reverse order. Since in a covered position of the vehicle very small air spaces are formed between the cover and the upper surfaces of the vehicle body, the air in these spaces is quickly heated and functions as a medium for transfer of heat from cover to the vehicle.

U.S. Pat. No. 6,276,381 issued in 2001 to P. O'Brein discloses a vehicle cover that may be stored in a convenient place such as the car trunk, then taken out and unfolded, and then installed on the vehicle. The cover is made of a fabric or textile such as canvas. When the vehicle must be used, the cover is removed, allowed to dry (if necessary), folded up, and stored. One problem associated with this design is inconvenience: it takes time to fold and unfold, and store, the vehicle cover. Furthermore, if the vehicle is located in a country with a very hot climate, under the effect of direct sun rays which are substantially perpendicular to the upper surface of the cover, at the noon time the interior of the vehicle covered with the protective cover of the type disclosed in U.S. Pat. No. 6,276,381 may be heated to a very high temperature due to a green-house effect caused by the cover. Since the entire body of the vehicle is covered from all sides, the spaces between the vehicle and the cover are not ventilated.

Another way to help preserve the finish on an automobile or other vehicle is to cover the vehicle with a vehicle cover when it is not in use. For example, U.S. Pat. No. 3,992,053 issued in 1976 to L. D. Hrytzak, et al. discloses a sun shield for automobiles that comprises a strip of screening material, which is stored on a roller within a cylindrical container attached to the automobile. When in use, the material is drawn out of the container through a slit therein, and is pulled over the automobile and attached at its free end to the automobile so that the roof is shielded. The screening material is kept spaced from the automobile bodywork by means of legs, which fold up when the sun shield is stored. A disadvantage of this device is that for forming a ventilated space between the cover material and the surface of the vehicle body, the device requires the use of an additional structure in the form of foldable legs, which has to be permanently stored in the vehicle's trunk.

The applicant of the present patent application has invented an extremely simple protective cover for a vehicle which is disclosed in U.S. Pat. No. 6,981,509 issued to the applicant (S. Sharapov) in 2006. This cover comprises a sheet or a web of a flexible material that possesses a property of buckling or curving in the upward direction from the vehicle with the formation of a canopy-type shield for protecting the vehicle from direct sun rays, birds' droppings, etc. The sheet has a length exceeding the length of the upper surface periphery of the vehicle so that the upwardly curved canopy is formed either by applying two oppositely directed forces to the opposite ends of the sheet or by prestressing the sheet. The sheet can be made from plastic or a fabric that incorporates springing metal strips that tend to curve upward when they are in a free state.

However, since the sheet or strips of flexible material have a significant length equivalent to the length of a vehicle and are arranged in the longitudinal direction of the vehicle, the flexible cover cannot be folded and wound into a roll for storage without the use of a special cassette of the types used for a tape reel. Even if the cover web is stored in a cassette in a spirally wound state, in order to provide efficient shading of the vehicle, such a cassette should have a length that is equal at least to the width of the vehicle. Another disadvantage is that the cover protects only the roof of a vehicle and leaves the sides of the vehicle body unprotected.

### OBJECTS AND SUMMARY OF THE INVENTION

It is an object of the present invention to provide a canopy-type vehicle cover for protecting a vehicle from overheating, direct sun rays hail, etc., which is simple in construction, inexpensive to manufacture, convenient in use, and can be easily folded and rolled for storage. It is another object to provide the canopy-type vehicle cover of the aforementioned type that covers the entire vehicle, including the sides of the vehicle body. It is a further object of the invention is to provide a vehicle cover of the aforementioned type that can be easily disassembled for storage in a small space, e.g., in a vehicle trunk and easily assembled for use.

The canopy-type vehicle cover of the invention comprises a cover web that is made from a flexible material, e.g. a water-proof fabric such as silk, Nylon, rubberized fabric, tarpaulin, canvas, etc., which is reinforced with strips of a resilient material that has springing properties and that are arranged in the transverse direction of the vehicle. An advantage of a dome-shaped canopy-type cover is that it forms a space above the roof that can be used for ventilation. The cover web can be easily wound into a roll without any resistance from the resilient elements since these elements are arranged in the transverse direction of the vehicle and in the direction parallel to the axis around which the material is rolled. If necessary, the resilient strips may be provided with means for assembling them into a single resilient member from two or more elements rigidly connectable in the longitudinal direction of the resilient member and easily disconnectable at the ends of elements, so that when the separate elements are disconnected, the length of the rolled cover web may be shortened. The resilient strips can be arranged transversely to the vehicle length and placed between the layers of a two-layered cover web. When the cover is installed into a working vehicle-protecting position, the side surfaces of the vehicle body are covered by side flaps of the cover web which are attached to lateral sides of the resiliently deformable part of the cover. In order to form a canopy above the vehicle roof, forces which are directed opposite to each other are applied to the opposite ends of the resilient elements. Under the effect of these forces, the resilient elements are curved as bows and stretch the web thus forming a dome-like configuration above the vehicle roof. At the same time, the side flaps, the side edges of which are attached to the vehicle bottom of the vehicle body, e.g., by hooks, are tightly pressed to the sides of the vehicle body. The aforementioned oppositely directed forces are developed by a pair of flexible cords which are threaded through openings formed at the ends of the resilient elements on both side of the cover. When the ends of the side cords which are tied to each other at their ends are stretched in the opposite directions along the longitudinal axis of the vehicle, the distances between the opposite ends of the transversely arranged resilient elements are shortened whereby the resilient elements are curved upward and stretch the material of the web thus forming an dome-shaped configuration above the vehicle roof while tightly rapping the flaps around the vehicle sides.

### BRIEF DESCRIPTION OF THE DRAWINGS

FIG. 1 is a general plan view of the canopy-type vehicle protective cover of the invention.

FIG. 2A is a fragment A of FIG. 1 shown on a larger scale illustrating a pulling cord threaded through holes on the edge of the cover web.

FIG. 2B is a top view of a modified guide element located on edges of the cover web for guiding the puling cords.

FIG. 2C is a side view of the guide element of FIG. 2B.

FIG. 3 is a three-dimensional view that illustrates the vehicle cover of the invention installed on a vehicle in a working position.

FIG. 4 is a plan view of a modified vehicle cover, which is intended for covering not only the roof but the entire vehicle including the sides of the vehicle body.

FIG. 5 is a three-dimensional view that illustrates the vehicle cover of FIG. 4 installed on a vehicle in a working position.

FIG. 6 is three-dimensional view that shows the vehicle cover of FIGS. 1 to 5 wound into a roll.

FIG. 7 is a sectional view in a transverse direction of the vehicle cover that shows a resilient strip of the vehicle cover composed of two interconnected parts and the structure of the connection element.

FIG. 8 is a sectional view in a transverse direction of the vehicle cover that shows the resilient strip of FIG. 7 placed between the layers of a two-layer web or inserted into special pockets formed for guiding the strips in the transverse direction of a vehicle.

FIG. 9 is a view similar to FIG. 8 that shows a resilient single-piece strip of FIGS. 1 to 5 placed between the layers of a two-layer web or inserted into special pockets formed for guiding the strips in the transverse direction of a vehicle.

FIG. 10 is a plan view of a vehicle cover with resilient strips of FIG. 7, the parts of which are disconnected for folding the web in half prior to winding it into a roll.

FIG. 11 is a three-dimensional view of a resilient strip that consists of two parts interconnected by a hinge that allows buckling of the strip as a single piece in one direction and folding thereof in another direction.

FIG. 12 is a sectional view that shows details of the hinge shown in FIG. 11.

FIG. 13 is a top view of a vehicle cover of another modification in which the pulling cords are arranged along each resilient strip and oriented in the transverse direction of the vehicle cover.

FIG. 14 is a view of a vehicle cover of FIG. 13 with the resilient strips arch-shaped by pulling the cords as strings of a bow.

### DETAILED DESCRIPTION OF THE INVENTION

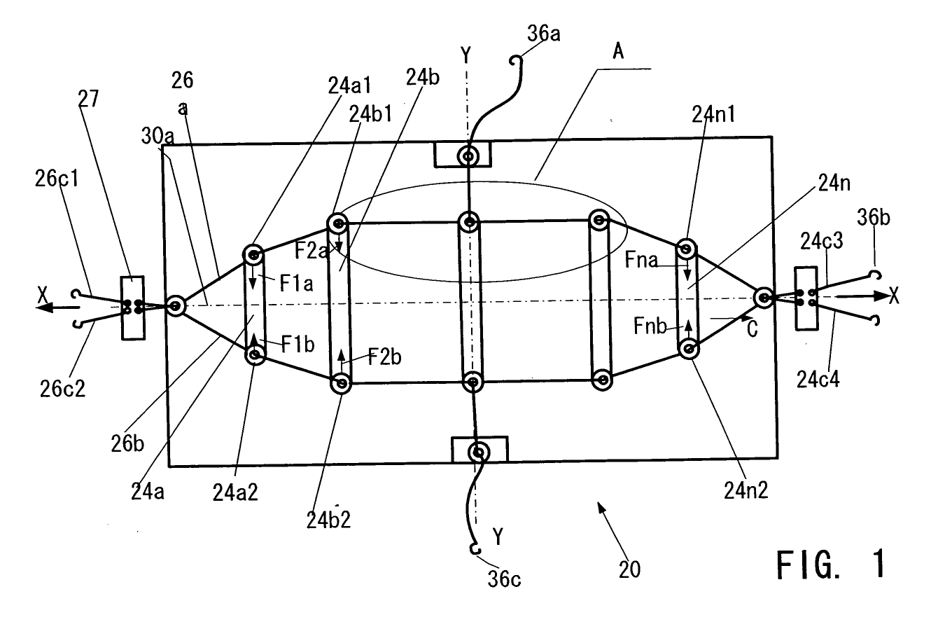

A general plan view of the canopy-type vehicle protective cover of the invention is shown in FIG. 1. The protective cover, which as a whole is designated by reference numeral 20, consists of a cover web 22 which in an unfolded or spread-out state has, in the embodiment of FIG. 1, a substantially rectangular shape. The cover web material may be made from a fabric such silk, thin plastic film, rubberized fabric, tarpaulin, canvas, etc. If necessary, the web is not necessarily rectangular and may have a different configuration limited by its boundary which depends on the shape of an object to be covered.

The cover web 22 is reinforced by strips 24a, 24b, . . . 24n of a resilient material that has springing properties and that are arranged in the transverse direction Y-Y of a vehicle (not shown in FIG. 1). Axis X-X designates a longitudinal direction of the web and of the vehicle. The resilient strips 24a, 24b, . . . 24n may be made from metal or plastic, and may have a greater length in the middle of the protective cover and shorter length at the ends of the web. In particular, the length of the resilient strips may correspond to the width of the vehicle in the respective areas of the vehicle's top view.

This space that is formed above the vehicle roof when the cover web 22 is deformed in a dome-like manner under the effect of buckling of the resilient strips 24a, 24b, . . . 24n can be used for ventilation and protects the vehicle from direct sun rays as well as from contact with the material of the web 22 that may be wet from the rain, hail, etc.

The resilient strips 24a, 24b, . . . 24n can be attached to the material of the cover web 22, e.g., by attachment elements 24a1, 24a2, 24b1, 24b2 . . . 24n1, 24n2. The attachment element may comprise rivets, buttons, screws and nuts, etc., and are located in the side margins of the web. In a preferable embodiment, the attachment elements 24a1, 24a2, 24b1, 24b2 . . . 24n1, 24n2 have through holes for threading flexible cords 26a and 26b through the neighboring holes so that the cords extend in directions essentially parallel to the longitudinal direction X-X of the web.

In FIG. 1, reference numeral 27 designates a clamping mechanism, e.g., a screw or clamp that clamps the cords together in a pulled out position for fixing the resilient strips in a deformed or arch-shaped state.

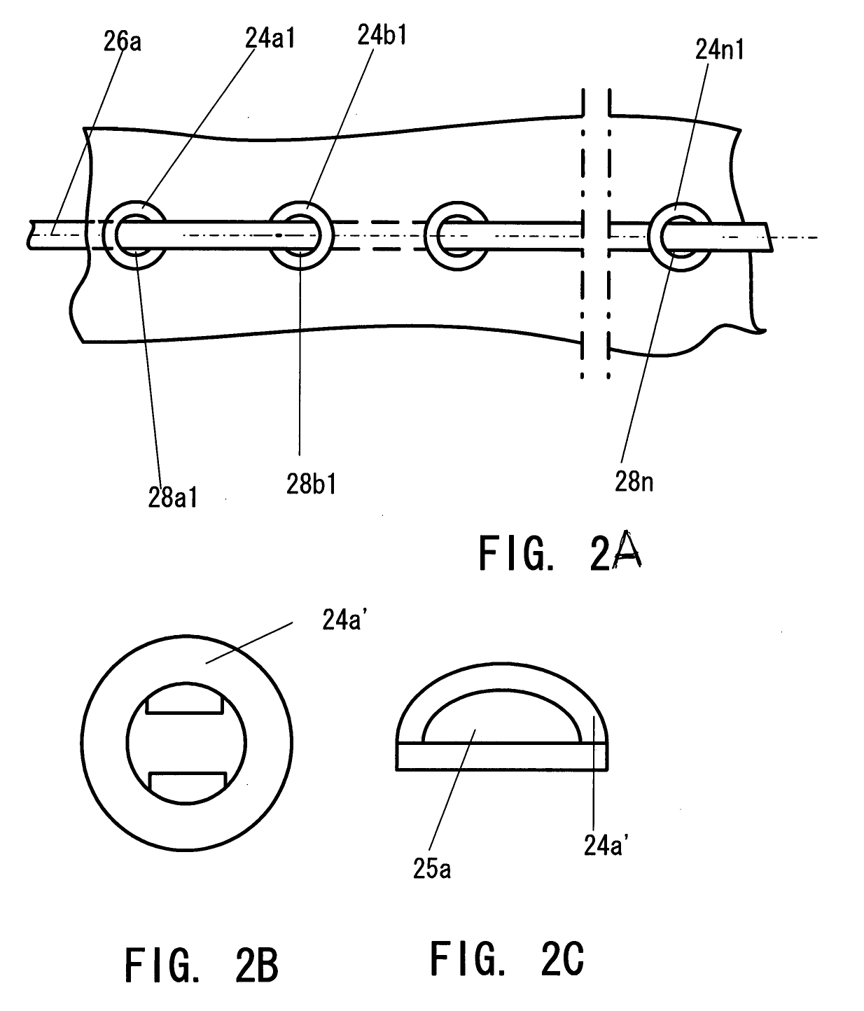

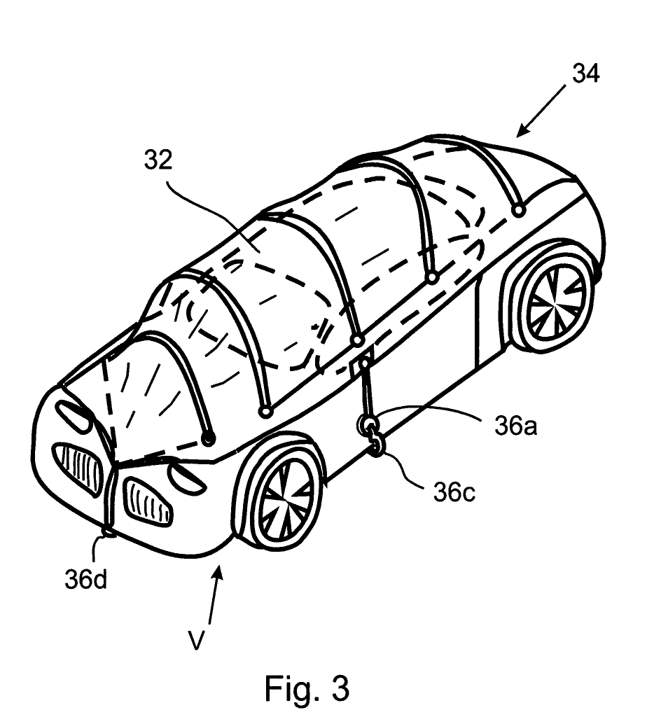

As shown in FIG. 2A, which is a fragment A of FIG. 1 shown on a larger scale, the cord 26a is threaded through the neighboring through holes 28a, 28b, . . . 28n of the neighboring attachment elements 24a1, 24b1, . . . 24n1, etc. so that sections of the cord 26a are guided in an alternating order over the material of the web 22 and under the material of the web 22. The same arrangement is provided on the other lateral side of the cover web 22 for the cord 26b. One ends 26a1 and 26b1 of the flexible cords 26a and 26b can be tied up together, e.g., at a point 30 (FIG. 1), while the opposite ends 26c1 and 26c2 of the cords 26a and 26b extend beyond the outlines of the cover web 22 substantially in the directions close and parallel to the longitudinal axis X-X (FIG. 1).

FIG. 2B is a top view of a modified guide element 24a′ located on edges of the cover web for guiding the puling cords, and FIG. 2C is a side view of the guide element 24a′. The cord is threaded through the opening 25a.

When the point 30a (FIG. 1) is fixed or pulled in the direction of arrow B and the opposite ends 26c3 and 26c4 of the flexible cords 26a and 26b are pulled in the direction of arrow C, the opposite ends of the resilient strips experience the effect of pairs of forces directed oppositely towards each other. Thus, the forces F1a and F1b are applied to the opposite ends of the resilient strips 24a, 24b, . . . 24n and cause them to curve or buckle in the upward direction whereby the cover web 22 is stretched and shaped as a dome or a field cap with a space 32 above the roof 34 of a vehicle V, which is shown in FIG. 3. It is understood that in order to cover not only the roof, but the entire vehicle, the web 22 should have a width W that exceed the width of the vehicle, e.g., with a factor of 1.5 to 2. The length of the vehicle cover web is the same as the length of the vehicle part that should be protected by the cover 20. For securing the cover web to the vehicle, e.g., to the bottom of the vehicle body, the cover web 22 is provided with hooks, clamps, or other attachment members 36a, 36b, 36c, and 36d (FIG. 1) only two of which, i.e., 36c and 26d are shown in FIG. 3. For example, as shown in FIGS. 1 and 3, one of the attachments member, e.g., 36c, is made in the form of a loop for engagement with the hook 36a arranged on the opposite side of the web 22, so that the hook 36 can be guided under the vehicle to the opposite side of the vehicle and engaged with the loop 36c.

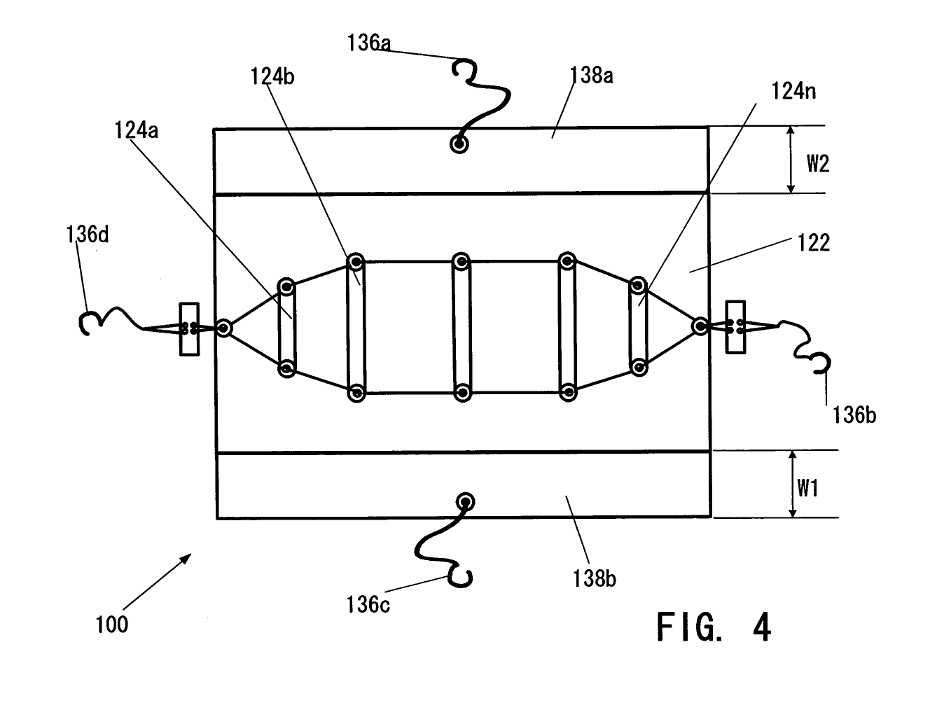

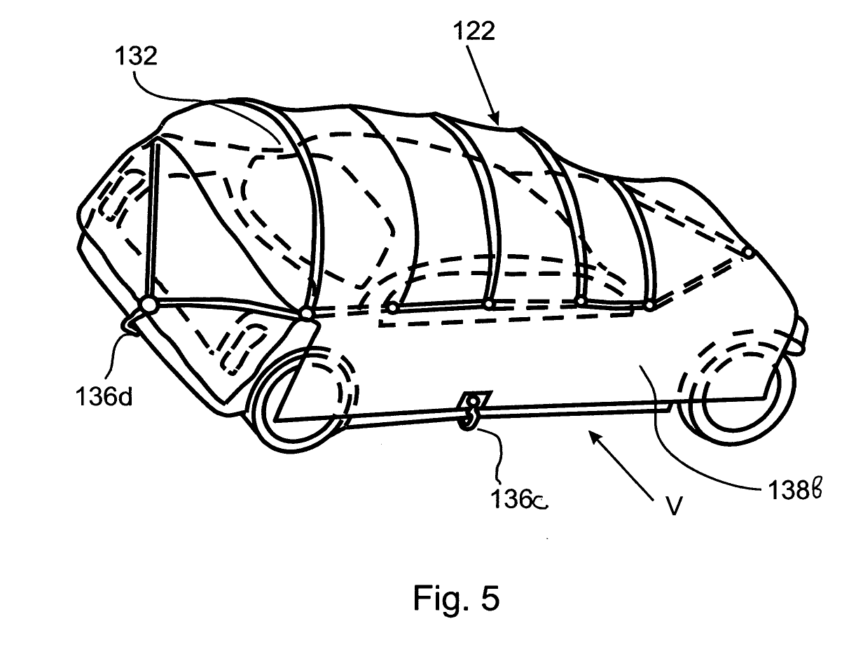

FIG. 4 shows a modified vehicle cover 100 which is intended for covering not only the roof but the entire vehicle including the sides of the vehicle body. In general, the vehicle cover 100 is the same as the vehicle cover 20 shown in FIGS. 1 to 3 and differs from it by a provision of side flaps 138a and 138b. Since the remaining parts of the vehicle cover 100 are the same as those in the modification of FIG. 1 to 3, their description is omitted and they are designated by the same reference numerals with an addition of 100. For example, the resilient strips are designated as 124a, 124b, . . . 124n, etc. FIG. 5 illustrates the vehicle cover 100 in the vehicle protecting position. It can be seen that portion 122 of the web (FIG. 4) forms above the vehicle roof a dome-like space 132, while the side flaps 138a (not seen in FIG. 5) and 138b cover the sides of the vehicle body.

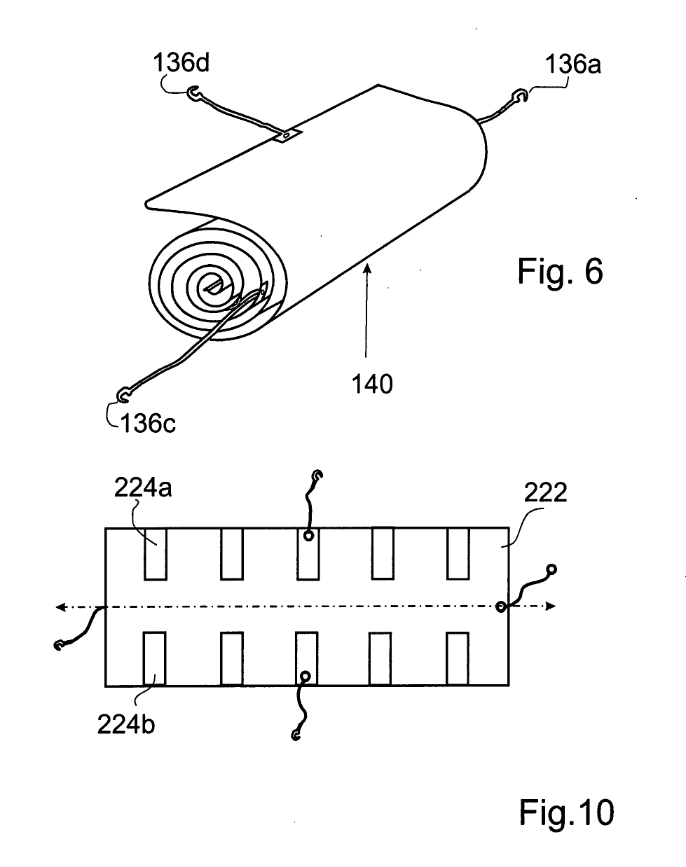

As shown in FIG. 6, the cover webs 22 and 122 can be easily wound into a roll 140 without any resistance from the resilient strips 24a, 24b, . . . 24n and 124a, 124b, . . . 124n, since these strips are arranged in the transverse direction of the vehicle and in the direction parallel to the axis Y-Y (FIG. 1) around which the material is rolled.

However, with the structures shown in FIGS. 1 to 6, the roll 140 will have a length exceeding the width of the vehicle and therefore such a roll cannot be stored in the vehicle's trunk and has to be either stored in the garage or another place or can be transported and stored on the rack that is provided on the vehicle roof.

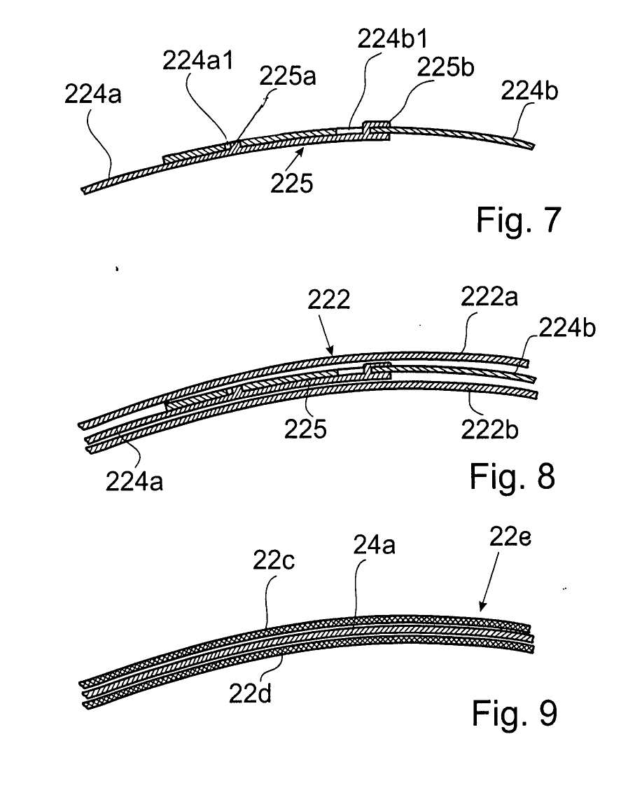

In order to reduce the width of the rolled vehicle cover to the dimensions suitable for placing it into the vehicle's trunk, the resilient strips may be provided with means for assembling them into a single resilient member from two or more elements rigidly connectable in the longitudinal direction of the resilient member and easily disconnectable when necessary, for folding the web in half and for winding the web into a roll having a twice shorter length. An example of such resilient elements is shown in FIG. 7, where reference numeral 224a designates a first resilient element, reference numeral 224b designates a second resilient element, and reference numeral 225 designates a connection member that rigidly interconnects the parts 224a and 224b. The connection member 225 shown in FIG. 7 is a plate that has a first projection 225a and a second L-shaped projection 225b. The first projection 225a is snapped into the opening 224a1 of the first resilient element 224a, and the L-shaped projection 225b is inserted into the elongated opening 224b1 of the second resilient element 224b, and then the resilient element 224b is shifted in the direction of arrow D in order to prevent disconnection of the resilient element 224b from the connection member 225 when the resilient elements are deformed during curving.

FIG. 8 shows an arrangement in which the resilient element parts 224a and 224b interconnected by the connection member 225 are placed between the layers 222a and 222b of a two-layer web fabric 222. Alternatively, reference numerals 222a and 222b may designate strip-like pockets arranged in the transverse direction of the vehicle cover and made from fabric. The pockets have a width sufficient for inserting the resilient strips 24a, 224a, etc. FIG. 9 shows an arrangement of a single-piece resilient element, such as elements 24a, 24b, . . . 24n, placed between the layers 22c and 22d of a two-layer web 22e. The resilient elements 24a, 24b, . . . 24n can be removed from the pocket for washing and cleaning of the web.

FIGS. 7 and 8 show modification of the vehicle cover with resiliently deformable strip parts 224a and 224b which can be disconnected from each other for folding the web fabric 222 in half, so that the length of the rolled cover will be reduced to the dimensions suitable for placing the rolled cover into the vehicle trunk. This is shown in FIG. 10 where the vehicle cover web 222 is shown with a pair of the resilient strips, such as 224a and 224b, etc. disconnected from each other, so that the web cover web 222 can be folded in half along the axis X-X (FIG. 1), and then the folded web can wound into a roll having a length equal to W/2.

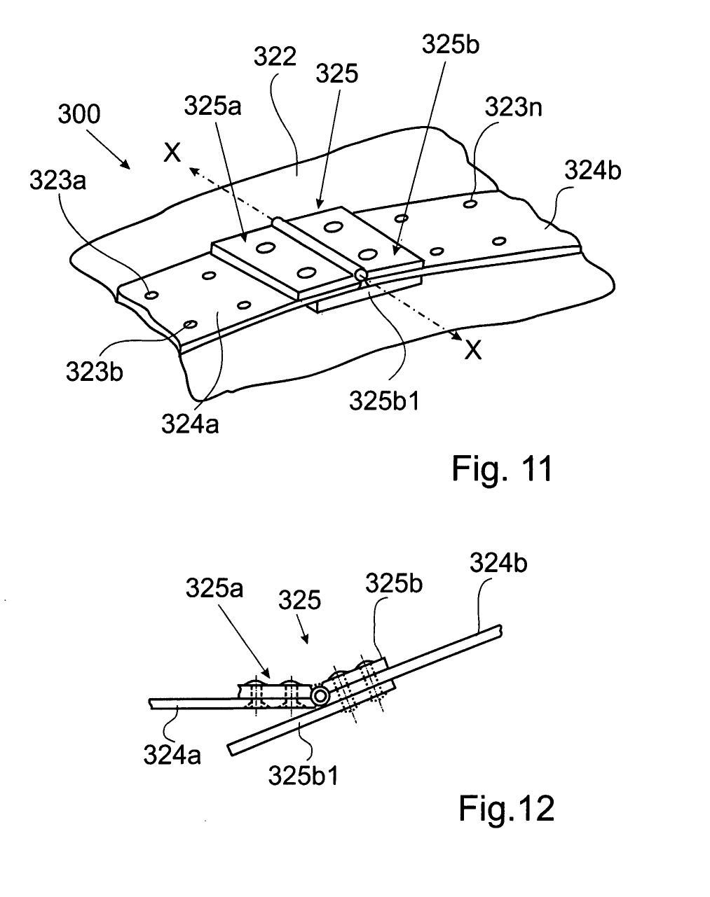

FIG. 11 and FIG. 12 show another modification of the foldable vehicle cover 300. A web 322 is secured to the resilient elements, such elements 324a and 324b, e.g., by rivets 323a, 323b, . . . 323n. In points on the longitudinal axis X-X of the cover 300, the latter is provided with a hinges 325 that allow folding of the web 322 in half along the axis X-X. As shown in FIG. 12, which is a side sectional view across the hinge 325, the latter consists of two pivotally connected members 325a and 325b which are attached to the web fabric 322. The part 325b has a stopper 325b1. This stopper does not prevent turning of the hinge part 325b relative to the hinge part 325a in the counterclockwise direction, when the cover web 322 is folded, but prevents turning of the hinge part 325b relative to the hinge part 325a for more than 180° from the folded position. As a result, during curving or buckling both parts of the resilient elements 324a and 324b behave as a single resilient strip.

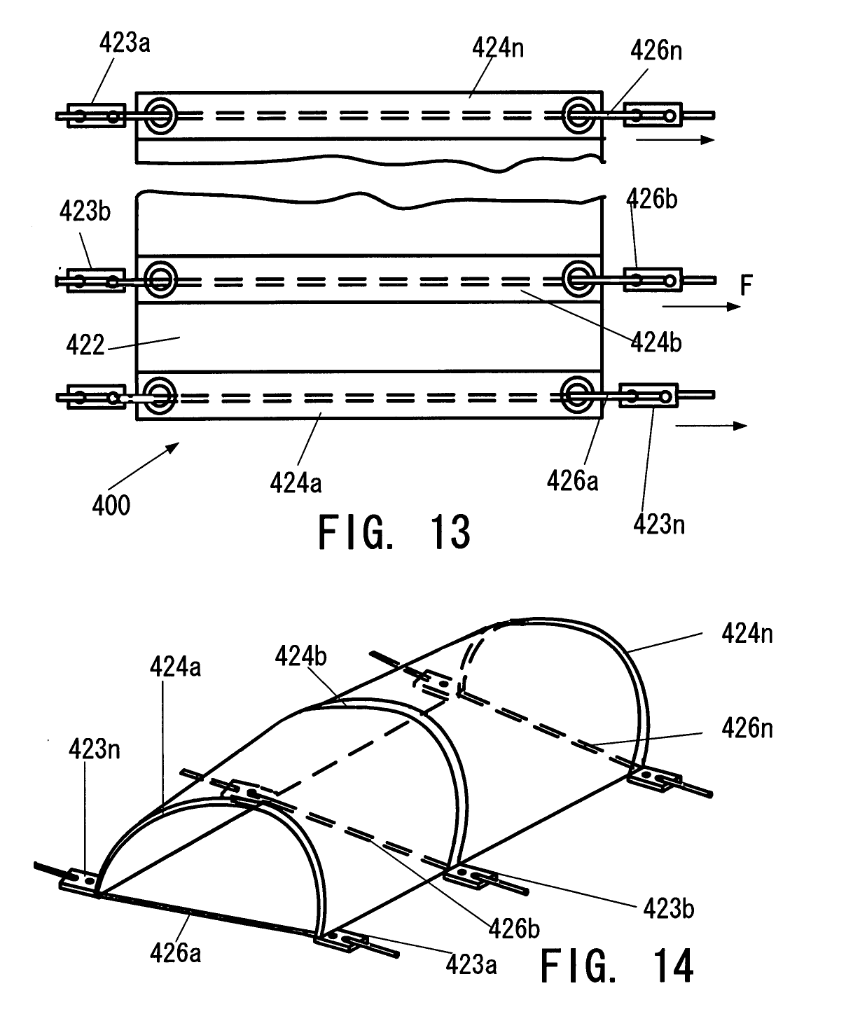

FIG. 13 is a plan view that shows another modification of the vehicle cover of the invention. In this modification, the vehicle cover 400 is the same as in the previous modifications with the exception that the flexible cords 426a, 426b, . . . 426n are arranged along the resilient strips 424a, 424b, . . . 424n. One ends of the cords are attached to the end of the strips on one side of the web 422, and the other ends extend from the opposite side of the web 422. The dome-shaped canopy is formed on the same principle of moving the opposite ends of the resilient strips 424a, 424b . . . 424n towards each other. In fact, as shown in FIG. 14, each resilient strip and each cord act as a bow and string. At the exit from the side of the web 422 each cord 426a, 426b, . . . 426n is provided with a respective locking device 423a, 423b, . . . 423n. The locking device may be a screw, or the like. In operation, one side of the web, e.g., the left side of the web 422 is secured to the vehicle body, e.g., by jamming it with the left doors of the vehicle. The cords 426a, 436b, . . . 426n are then pulled in the direction of arrow F, and after the resilient strips are curved up as shown in FIG. 14, the cords are fixed relative to the resilient strips, e.g., by wrapping around the end of the strips as a string is fixed at the end of the bow, or by using the locking devices 423a, 423b, . . . 423n. The free ends of the cords are tied together and may be fixed in place by jamming with the right door or by securing to the bottom of the vehicle body with a hook, as in the previous modifications.

Thus, as has been shown above, the invention provides a canopy-type vehicle cover for protecting a vehicle from overheating, direct sun rays hail, etc., which is simple in construction, inexpensive to manufacture, convenient in use, and can be easily folded for storage in the trunk of the vehicle. The canopy-type vehicle may cover only the roof of the vehicle or can be made in the form for covering the entire vehicle including the sides of the vehicle body. The vehicle cover of the invention can be easily disassembled for storage in a small space and easily assembled for use.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, in a plan view the vehicle cover web may have various shapes, depending on the configuration of the vehicle, e.g., square, rectangular, oval, elliptical, etc. The web of the vehicle cover can be made from various materials such as various fabrics and plastic films. The web of the vehicle cover can be secured to the vehicle by hooks, clamps, hooks and loops, or one edge of the web can be jammed by the vehicle doors while buckling of the resilient elements can be carried out by pulling the cords on the other side of the web. The vehicle cover of the invention may be used for covering not only a vehicle but any other object and can be used as a tent, hangar, shed, storage, or as a greenhouse with transparent material of the web. The web may be provided with valve slits that function as valves that could be opened under the pressure of air generated by the wind. The holes for guiding the cords can be made separate from the devices for attachment of the strips to the material of the web.

1. A vehicle cover comprising:
a web made from a flexible material, said web having a longitudinal direction that in use coincides with the longitudinal direction of a vehicle, which is to be covered with the vehicle cover, and a transverse direction which coincides with the transverse direction of the vehicle, the web having a configuration defined by the web boundary;
a plurality of resilient strips arranged essentially in the aforementioned transverse direction of the web and attached at least at their ends to the web; and
a pulling mechanism connected to the resilient strips so that when the pulling mechanism is pulled, a pair of forces directed towards each other are applied to the ends of each resilient strip for curving each resilient strip and for deforming the web to form a dome-shaped configuration.

2. The vehicle cover of claim 1, wherein the resilient strips have holes on their ends and wherein the pulling mechanism comprises flexible cords threaded through the aforementioned holes, the flexible cords having their ends extending beyond the boundary of the web configuration.

3. The vehicle cover of claim 2, wherein the aforementioned ends of the cords that extend beyond the boundary of the web configuration have a clamping mechanism for clamping the cords together in a pulled out condition for fixing the resilient strips in an arch-shaped state.

4. The vehicle cover of claim 3, wherein the aforementioned web configuration has dimensions sufficient for covering at least the roof of a vehicle.

5. The vehicle cover of claim 3, wherein the aforementioned web configuration has dimensions sufficient for covering the entire vehicle.

6. The vehicle cover of claim 3, wherein each resilient strip consists of at least two parts which are connected by a connection device.

7. The vehicle cover of claim 6, wherein the connection device is disconnectable ion order to allow folding of the web in half and rolling of the folded web.

8. The vehicle cover of claim 6, wherein the connection device is a hinge that allows arching of each resilient strip in one direction and allows folding of each resilient strip in the second direction which is opposite to the first direction.

9. The vehicle cover of claim 3, wherein the cords are threaded sequentially through the neighboring holes on one side of the web so that the cords extend in directions essentially parallel to the aforementioned longitudinal direction of the web.

10. The vehicle cover of claim 9, wherein each resilient strip consists of at least two parts which are connected by a connection device.

11. The vehicle cover of claim 10, wherein the connection device is disconnectable in order to allow folding of the web in two and rolling of the folded web.

12. The vehicle cover of claim 10 wherein the connection device is a hinge that allows arching of each resilient strip in one direction and allows folding of each resilient strip in the second direction which is opposite to the first direction.

13. The vehicle cover of claim 3, wherein each resilient strip has a pulling cord which is threaded through the holes located on the opposite ends of each resilient strip so that each resilient cord is oriented in the transverse direction of the web and pulling of the cords curves the respective resilient strip as a sting bends a bow.

14. The vehicle cover of claim 13, wherein each resilient strip consists of at least two parts which are connected by a connection device.

15. The vehicle cover of claim 14, wherein the connection device is disconnectable ion order to allow folding of the web in two and rolling of the folded web.

16. The vehicle cover of claim 14 wherein the connection device is a hinge that allows arching of each resilient strip in one direction and allows folding of each resilient strip in the second direction which is opposite to the first direction.

17. The vehicle cover of claim 1, wherein the web is made from a flexible material selected from fabric and plastic, and wherein the resilient strips are made from a material selected from metal and plastic.

18. The vehicle cover of claim 3, wherein the web is made from a flexible material selected from fabric and plastic, and wherein the resilient strips are made from a material selected from metal and plastic.

19. The vehicle cover of claim 9, wherein the web is made from a flexible material selected from fabric and plastic, and wherein the resilient strips are made from a material selected from metal and plastic.

20. The vehicle cover of claim 10, wherein the web is made from a flexible material selected from fabric and plastic, and wherein the resilient strips are made from a material selected from metal and plastic.
